(19) United States
(12) Patent Application Publication
(10) Pub. No.: US 2023/0392573 A1
(43) Pub. Date: Dec. 7, 2023

(54) Tidal stream generation apparatus with pump

(71) Applicant: Feng-Yan Shen, Pingtung (TW)

(72) Inventor: Feng-Yan Shen, Pingtung (TW)

(21) Appl. No.: 18/234,903

(22) Filed: Aug. 17, 2023

(51) Int. Cl. F03B 13/26; F03B 11/00

(52) U.S. Cl. CPC F03B 13/264; F03B 11/00; F05B 2260/4031

(57) ABSTRACT

A generating apparatus for generating electrical power from a water flow to electrical energy includes a pump; pipes; tidal stream generation devices; and drains. The pump is connected to and in fluid communication with the pipes. The pump may pump seawater to the pipes and sweater may further flow to the tidal stream generation devices so that the tidal stream generation devices may generate electrical power from a seawater flow to electrical energy. The tidal stream generation device includes a turbine driven by seawater, a shaft co-rotated with the turbine, a reduction gearbox operatively connected to the shaft, an output shaft extending out of the reduction gearbox, and an alternator driven by the output shaft to convert mechanical energy to electrical energy in the form of AC, and an electrical grid electrically connected to the alternator. The drain is connected to the pipe for flowing seawater to the sea.

### BACKGROUND OF THE INVENTION

### 1. Field of the Invention

The invention relates to tidal stream generators and more particularly to a tidal stream generation apparatus having a pump for pumping seawater from the sea to the apparatus so that the seawater flow can be used to generate electrical power.

### 2. Description of Related Art

Conventionally, tidal stream generators are mounted below or above the surface of the seawater. However, it may obstruct navigation.

There is a conventional apparatus for generating electrical power from a horizontal water flow. The apparatus comprises a fixed hub on a support structure and a power wheel arranged for rotation about a vertical axis about the hub. The power wheel includes rotor vanes adapted to cause rotation of the power wheel when the power wheel is subject to a substantially horizontal water flow. At least one generator can be provided on the hub to produce electrical power output from rotation of the power wheel relative to the hub. A shroud is rotationally mounted on the hub and arranged to cover at least some of the rotor vanes, so that the water flow is concentrated on the rotor vanes on only one side of the power wheel. A directional controller holds the shroud in a predetermined rotational position relative to the hub dependent on the direction of the water flow.

### SUMMARY OF THE INVENTION

It is therefore one object of the invention to provide a generating apparatus for generating electrical power from a water flow to electrical energy, comprising a pump; at least one pipe; at least one tidal stream generation device; and at least one drain; wherein the pump is connected to and in fluid communication with the at least one pipe, the pump is configured to pump seawater to the at least one pipe, and seawater is configured to further flow to the at least one tidal stream generation device so that the at least one tidal stream generation device is configured to generate electrical power from a seawater flow to electrical energy; and wherein each of the at least one drain is connected to the pipe so that seawater flowing from the tidal stream generation device is configured to further flow through the pipe and the drain prior to flowing to the sea.

Preferably, each of the at least one tidal stream generation device includes a turbine disposed in each of the at least one pipe and driven by seawater flowing from the pump, a shaft coaxially provided with and co-rotated with the turbine, a reduction gearbox operatively connected to the shaft, an output shaft extending out of the reduction gearbox, and an alternator driven by the output shaft to convert mechanical energy to electrical energy in the form of alternating current (AC), and an electrical grid electrically connected to the alternator.

Preferably, each of the at least one pipe is bent.

Preferably, each of the at least one pipe is straight.

Preferably, seawater used by each of the at least one tidal stream generation device flows to the sea.

Preferably, seawater used by each of the at least one tidal stream generation device flows to a fish pond.

The invention has the following advantages and benefits in comparison with the conventional art:

Each turbine is driven by seawater flowing from the pump through the pipe. The shaft thus rotates to activate the reduction gearbox. And in turn, the output shaft rotates to drive the alternator so that the alternator may convert mechanical energy to electrical energy in the form of AC.

The pipes can be bent so that seawater used by the tidal stream generation devices may flow to the sea for recycling purpose or the pipes are straight so that seawater used by the tidal stream generation devices flow to a fish pond that is stocked with fish and is used in aquaculture for fish farming.

Only one pump is sufficient to drive a number of tidal stream generation devices through a number of pipes.

Only one pump is sufficient in operation if there are more than one pump are provided, thereby increasing reliability.

The above and other objects, features and advantages of the invention will become apparent from the following detailed description taken with the accompanying drawings.

### BRIEF DESCRIPTION OF THE DRAWINGS

FIG. 1 schematically depict a tidal stream generating apparatus according to the invention;

FIG. 2 is a side elevation in part section of the tidal stream generation device in FIG. 1;

FIG. 3 is a perspective view of the tidal stream generation devices and associated components in a first preferred embodiment of the invention; and

FIG. 4 is a perspective view of the tidal stream generation devices and associated components in a second preferred embodiment of the invention.

### DETAILED DESCRIPTION OF THE INVENTION

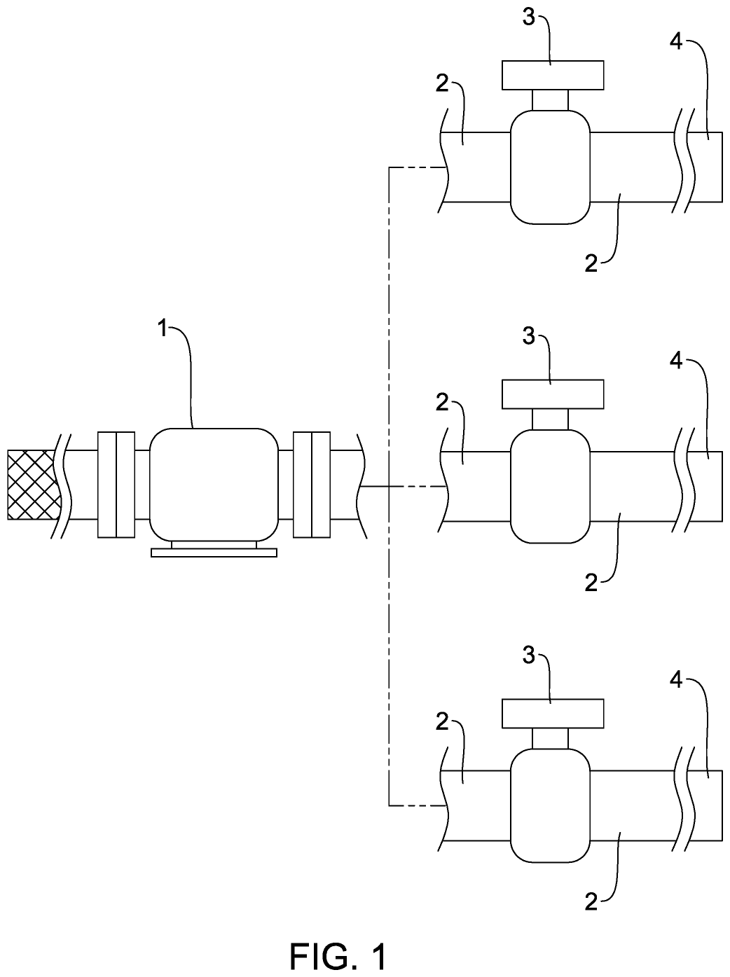

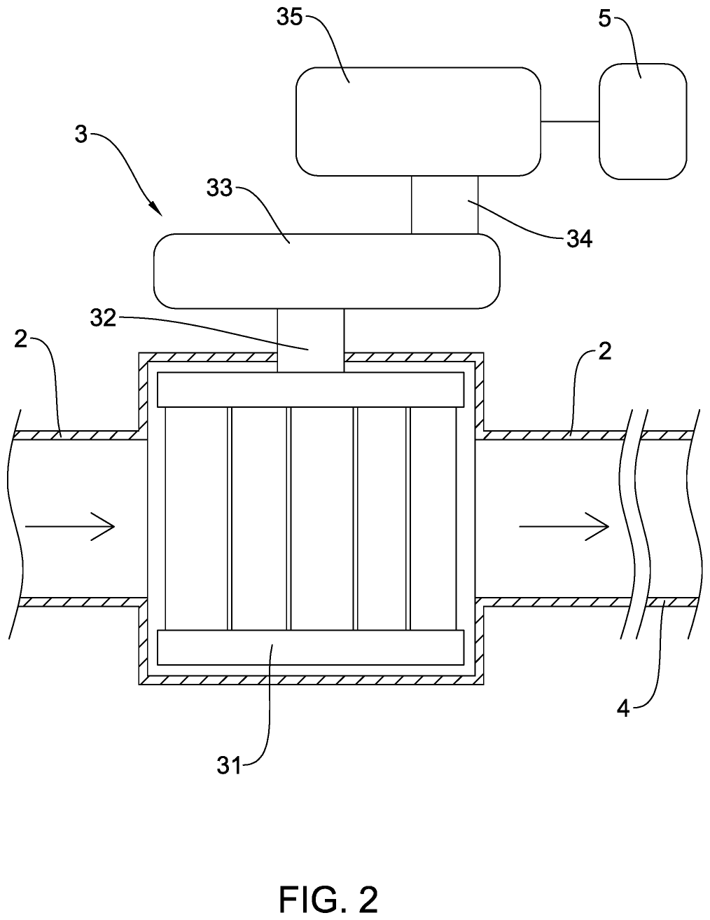

Referring to FIGS. 1 to 2, a tidal stream generating apparatus in accordance with the invention comprises a pump 1, a plurality of pipes 2, a plurality of tidal stream generation devices 3, and a plurality of drains 4 as discussed in detail below.

The pump 1 is connected to and in fluid communication with the pipes 2. The pump 1 pumps seawater to the pipes 2 and seawater may further flow to the tidal stream generation devices 3. An inlet of the pump 1 is provided a filter for filtering out coarse particles. There are more than one pump 1 in other embodiments in which only one pump 1 operates and other pumps 1 are inactivated when the tidal stream generating apparatus operates.

The tidal stream generation device 3 includes a turbine 31 provided in the pipe 2 and driven by seawater flowing from the pump 1, a shaft 32 coaxially provided with and co-rotated with the turbine 31, a reduction gearbox 33 having a number of meshed gears (not shown) and operatively connected to the shaft 32, an output shaft 34 extending out of the reduction gearbox 33, and an alternator 35 driven by the output shaft 34 to convert mechanical energy to electrical energy in the form of alternating current (AC) by means of a rotating magnetic field with a stationary armature. AC power is transmitted to an electrical grid 5 which in turn delivers same to consumers. The turbine 31 includes a plurality of blades (not shown) which co-rotate with the shaft 32 when flowing seawater is directed on the blades to create a force on the blades. The gears of the reduction gearbox 33 can change speed of rotation of the output shaft 34. The drain 4 is connected to the pipe 2 so that seawater flowing from the turbine 31 may further flow through the pipe 2 and the drain 4 prior to flowing to the sea.

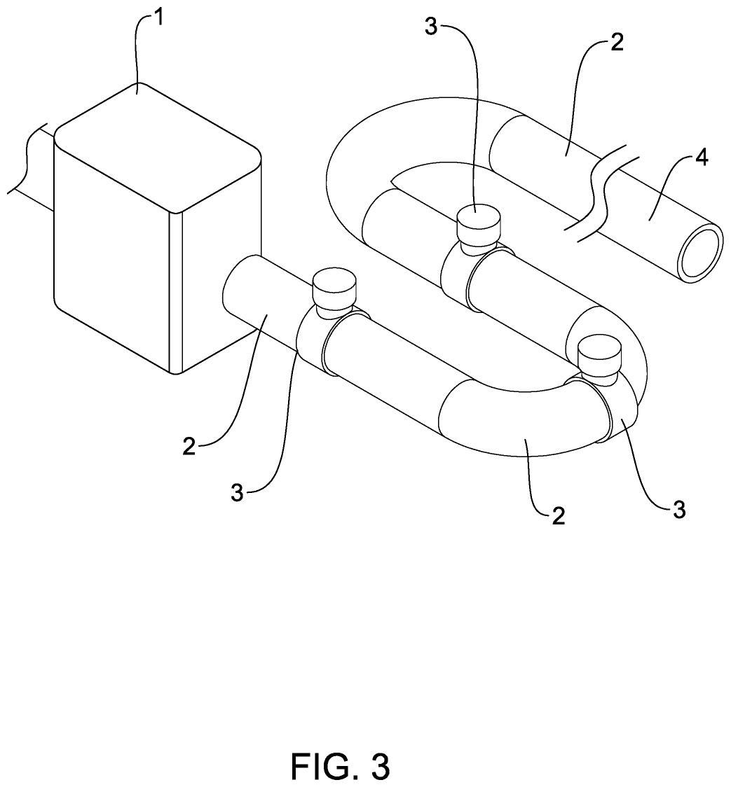

Referring to FIG. 3, in a first preferred embodiment of the invention the tidal stream generation devices 3 are provided in the pipes 2 which are bent. The tidal stream generation devices 3 uses seawater flowing from the pump 1 to generate electrical power. This embodiment has an advantage of flowing seawater to the sea for recycling purpose.

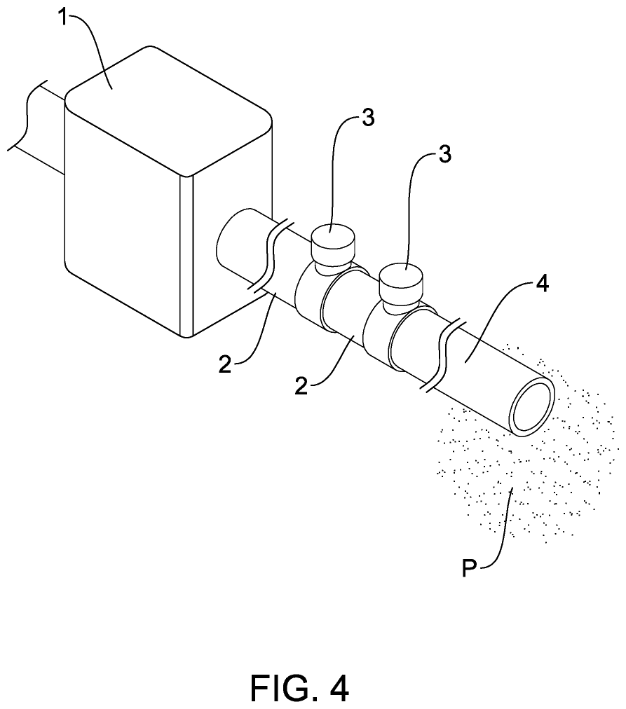

Referring to FIG. 4, in a second preferred embodiment of the invention the tidal stream generation devices 3 are provided in the pipes 2 which are straight. The tidal stream generation devices 3 uses seawater flowing from the pump 1 to generate electrical power. This embodiment has an advantage of flowing seawater to a fish pond P that is stocked with fish and is used in aquaculture for fish farming.

The invention has the following advantages and benefits in comparison with the conventional art:

Each turbine 31 is driven by seawater flowing from the pump 1 through the pipe 2. The shaft 32 thus rotates to activate the reduction gearbox. And in turn, the output shaft 34 rotates to drive the alternator 35 so that the alternator may convert mechanical energy to electrical energy in the form of AC.

The pipes 2 can be bent so that seawater used by the tidal stream generation devices 3 may flow to the sea for recycling purpose or the pipes 2 are straight so that seawater used by the tidal stream generation devices 3 flow to a fish pond that is stocked with fish and is used in aquaculture for fish farming.

Only one pump 1 is sufficient to drive a number of tidal stream generation devices 3 through a number of pipes 2.

Only one pump 1 is sufficient in operation if there are more than one pump 1 are provided, thereby increasing reliability.

While the invention has been described in terms of preferred embodiments, those skilled in the art will recognize that the invention can be practiced with modifications within the spirit and scope of the appended claims.

What is claimed is:

1. A generating apparatus for generating electrical power from a water flow to electrical energy, comprising:
a pump;
at least one pipe;
at least one tidal stream generation device; and
at least one drain;
wherein the pump is connected to and in fluid communication with the at least one pipe, the pump is configured to pump seawater to the at least one pipe, and seawater is configured to further flow to the at least one tidal stream generation device so that the at least one tidal stream generation device is configured to generate electrical power from a seawater flow to electrical energy; and
wherein each of the at least one drain is connected to the pipe so that seawater flowing from the tidal stream generation device is configured to further flow through the pipe and the drain prior to flowing to the sea.

2. The generating apparatus of claim 1, wherein each of the at least one tidal stream generation device includes a turbine disposed in each of the at least one pipe and driven by seawater flowing from the pump, a shaft coaxially provided with and co-rotated with the turbine, a reduction gearbox operatively connected to the shaft, an output shaft extending out of the reduction gearbox, and an alternator driven by the output shaft to convert mechanical energy to electrical energy in the form of alternating current (AC), and an electrical grid electrically connected to the alternator.

3. The generating apparatus of claim 1, wherein each of the at least one pipe is bent.

4. The generating apparatus of claim 1, wherein each of the at least one pipe is straight.

5. The generating apparatus of claim 1, wherein seawater used by each of the at least one tidal stream generation device flows to the sea.

6. The generating apparatus of claim 1, wherein seawater used by each of the at least one tidal stream generation device flows to a fish pond.
